(19) United States
(12) Patent Application Publication
(10) Pub. No.: US 2016/0063184 A1
(43) Pub. Date: Mar. 3, 2016

(54) DECISION SUPPORT IN PROFESSIONAL WORKFLOWS CONCURRENT WITH SERVICE PROVISIONING

(71) Applicants: Stephen S. Hau, Nashville, TN (US); Tuyen Tran, Nashville, TN (US); Alan Huffman, Nashville, TN (US); Craig A. Fields, Nashville, TN (US)

(72) Inventors: Stephen S. Hau, Nashville, TN (US); Tuyen Tran, Nashville, TN (US); Alan Huffman, Nashville, TN (US); Craig A. Fields, Nashville, TN (US)

(21) Appl. No.: 14/474,770

(22) Filed: Sep. 2, 2014

(51) Int. Cl. G06F 19/00

(52) U.S. Cl. CPC G06F 19/321; G06F 19/322

(57) ABSTRACT

A user device for professional workflow assistance provides decision support in the form of concise alerts in the form of immediate feedback (real-time or near real-time) analysis performed by a user device application based on locally stored rules. The decision support is rendered in a timely manner in a current session with the patient, client or customer to maintain a context of the information gathering and the concurrent consideration of the decision support provided. The decision maker need not retreat to an office or separate location for consideration and analysis of the decision support results, but instead immediately considers the application generated results on the rendering screen of the user device.

### BACKGROUND

Decision support systems (DSS) invoke computer resources to process information for generating a conclusion that aids or drives decisions, typically at a professional or upper management level. A cooperative DSS allows the decision maker to modify or consider the decision suggestions provided by the system, before implementing the recommended course of action, in contrast to co-called passive and active systems which are entirely dependent or independent, respectively, from user validation and control. DSSs are often considered to include knowledge base, data warehousing and on-line analytic processing (OLAP) concepts. Some professional realms, most notably in the medical fields, have been reluctant to adopt DSS support, most likely due to the individualized context between doctor and patient and the corresponding duty owed, coupled with a cognizance of potential liability and a psychological need to maintain control.

### SUMMARY

A decision support application operable in conjunction with a data entry, management and reporting system provides alerts responsive to entry of data items that warrant clinical and/or statistical feedback for consideration by the user entering the data. GUI (Graphical User Interface) based data defines a series of data items received from a user, and interrelations between data items analyzed by a rule based approach that identifies data items that fall outside of a statistical threshold, or data items that are subject to a statistical distribution based on professional analysis of other related data items. The users of the system are expected to be professionals of the field concerned with the data, such as doctors, lawyers, accountants, real estate, or other field that could benefit from real-time decision support in the context of a patient/client/customer meeting or session. Entry of a data item that triggers a rule generates an alert to indicate to the user the data item values that triggered the rule. A rule engine computes a result based on a triggered rule, and renders an alert in a designated window for consideration by the user. Alerts may advise the user regarding statistical or clinical factors, or may mandate completeness and validation constraints. Any number of alerts may be rendered simultaneously, responsively to any rules triggered by data items on a current screen form. In this manner, a professional user enjoys the benefit of supporting information based on the previous experience of colleagues and mentors encountering similar scenarios, as represented by the data items entered on a current form.

Configurations herein are based, in part, on the observation that conventional approaches to decision support in the medical fields tend to be limited, due in part at least to concerns over propriety information and professional liability, as well as a skepticism of general information over professional intuition. Unfortunately, therefore, conventional approaches to decision support in the medical field suffers from the shortcoming of being limited to invariant situations such as drug interactions and patient allergies.

Accordingly, configurations herein substantially overcome the above-described shortcomings by providing a context-specific rule-based alert system that receives patient specific data items in the context of a point of care session, and renders a plurality of results in the form of on-screen alerts in a dedicated window that each correspond to a rule based observation about patient care based on the currently entered data items. The alerts occupy an alerts window on a GUI-based hand-held device, and remain updated in real time for each new data item entered.

Conventional decision support systems typically generate results at a different time and place than the decision they support. Often large volumes of data are coalesced and results are defined by data sets generated well after the time of gathering the data, and which further require substantial analysis by the decision maker. The disclosed approach presents decision support in the form of concise alerts based on immediate feedback (real-time or near real-time) analysis performed by a user device application based on locally stored rules. The decision support is rendered in a timely manner in a current session with the patient, client or customer to maintain a context of the information gathering and the concurrent consideration of the decision support provided. The decision maker need not retreat to an office or separate location for consideration and analysis of the decision support results, but instead immediately considers the application-generated results on the rendering screen of the user device.

An example arrangement discussed below concerns a medical data entry environment, however other uses include any suitable environment where interrelations between data items may be drawn and professional judgment concerning the interrelation is applicable.

Alternate configurations of the invention include a multiprogramming or multiprocessing computerized device such as a multiprocessor, controller or dedicated computing device or the like configured with software and/or circuitry (e.g., a processor as summarized above) to process any or all of the method operations disclosed herein as embodiments of the invention. Still other embodiments of the invention include software programs such as a Java Virtual Machine and/or an operating system that can operate alone or in conjunction with each other with a multiprocessing computerized device to perform the method embodiment steps and operations summarized above and disclosed in detail below. One such embodiment comprises a computer program product that has a non-transitory computer-readable storage medium including computer program logic encoded as instructions thereon that, when performed in a multiprocessing computerized device having a coupling of a memory and a processor, programs the processor to perform the operations disclosed herein as embodiments of the invention to carry out data access requests. Such arrangements of the invention are typically provided as software, code and/or other data (e.g., data structures) arranged or encoded on a computer readable medium such as an optical medium (e.g., CD-ROM), floppy or hard disk or other medium such as firmware or microcode in one or more ROM, RAM or PROM chips, field programmable gate arrays (FPGAs) or as an Application Specific Integrated Circuit (ASIC). The software or firmware or other such configurations can be installed onto the computerized device (e.g., during operating system execution or during environment installation) to cause the computerized device to perform the techniques explained herein as embodiments of the invention.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a context diagram of a computing environment suitable for use with configurations disclosed herein;

FIG. 2 is a flowchart of decision support in the environment of FIG. 1;

FIGS. 3a-3b show a user interface screen for decision support in the environment of FIG. 1;

FIGS. 4a-4d show a rendering of decision support alerts according to the flowchart of FIG. 2; and

FIG. 5 shows logic for determining alerts for rendering as in FIG. 4.

### DETAILED DESCRIPTION

Information exchanges between parties are common in professional contexts for rendering services. In a doctor/patient context, for example, a doctor conducts an exchange with the patient to inquire about medical history, symptoms, and lifestyle to identify a diagnosis and recommend a course of treatment. In conventional approaches, paper and forms are often employed for such exchanges. In an automated workflow and/or paperless office setting, a software based application launched on a personal electronic device (PED) such as an iPad® may be employed for the exchange. Such a software application may be that as disclosed in co-pending U.S. patent application Ser. No. 14/325,919, filed Jul. 8, 2014, entitled “DATA FORM GENERATION AND GATHERING” by the assignee of the present application, incorporated herein by reference. During a context of the exchange, typically defined by a visit to the doctor's office, the information received during exchange is entered and considered by the doctor, and a diagnosis and treatment plan generated from the analysis. The context therefore defines a relatively short period of information retrieval and professional analysis, during which the doctor's experience is brought to bear on a “picture” of patient care represented by the received information. Decision support as disclosed by the present application is rendered on the PED during this exchange, for consideration by the doctor. The received information is also stored for future decision support as discussed further below.

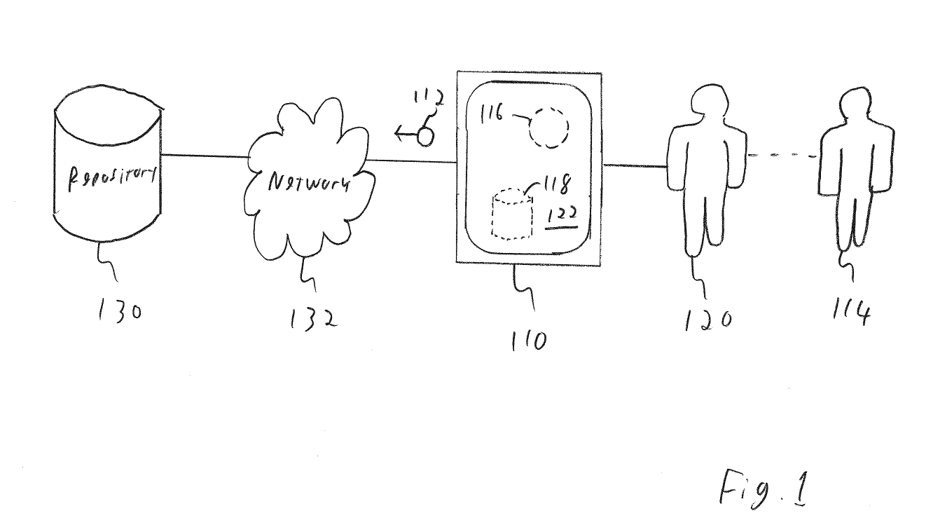

FIG. 1 is a context diagram of a computing environment suitable for use with configurations disclosed herein. Referring to FIG. 1, in a computing environment 100 suitable for information gathering and data retrieval, a user device 110 is responsive to a user 120 for receiving data items 112 gathered from a service recipient 114, such as a patient, client or customer. The launched software application 116 generates GUI screens 122 for rendering and receiving the data items 112. Local storage 118 on the user device 110 stores the data items 112, along with other logic discussed further below, for supporting the application 116. The received data items 112 are also transmitted to a central repository 130 via a public access network 132 such as the Internet or other suitable LAN (Local Area Network), WAN (Wide Area Network), Intranet or a combination of such interconnections. The user 120 may be a professional such as a doctor, lawyer, accountant, advisor to consultant, or an assistant such as a nurse, records specialist, secretary or other support staff. The received data items 112 typically result from a conversation between the user 120 and service recipient 114, and occur in the context of an interrogative exchange session during which information is both received and considered by the user for immediate or near real-time analysis by the user. In an example configuration depicted below, a doctor/patient exchange is employed as an example setting, therefore the user 120 role is undertaken by the doctor and the service recipient 114 role is undertaken by a patient, however other pairings of professional service rendering as indicated above equally applicable to configurations herein.

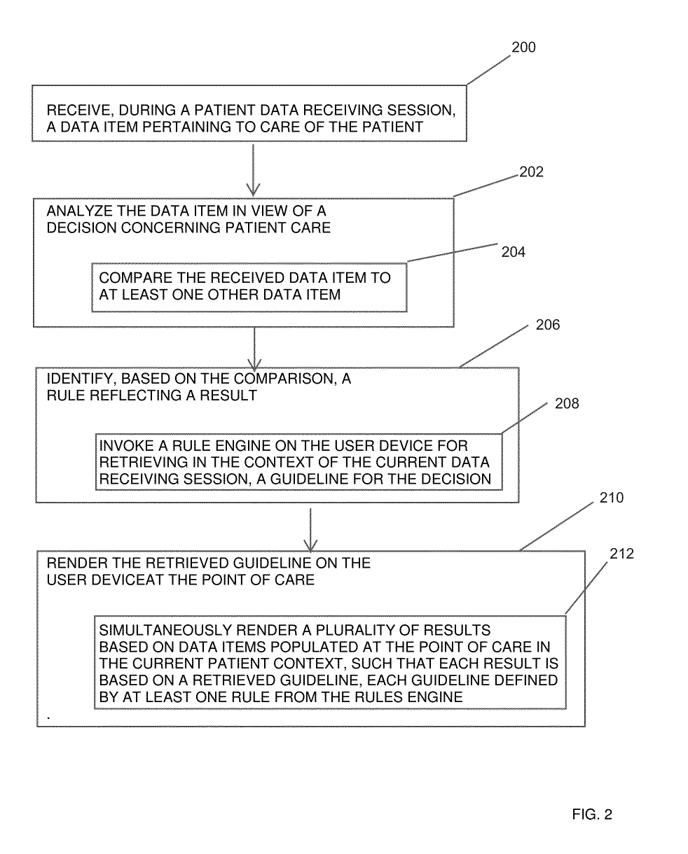

FIG. 2 is a flowchart of decision support in the environment of FIG. 1. Referring to FIGS. 1 and 2, the method for clinical decision support as disclosed herein includes, at step 200, receiving, during a patient data receiving session, a data item pertaining to care of the patient. This includes analyzing the data item in view of a decision concerning patient care, as shown at step 202. The user 120, typically a practitioner such as a doctor or nurse, enters the received information as data items on the user device. Analyzing the data items further includes comparing the received data item 150 to at least one other data item 150,′ as depicted at step 204, such as a previous entry on the same form or an entry from the patient history and biographic data. The application 116 identifies, based on the comparison, a rule reflecting a result, as shown at step 206.

Identifying the rule, in the example configuration, involves invoking a rule engine on the user device 110. The rule engine retrieves, in the context of the current data receiving session, a guideline for the decision, as depicted at step 208. The current data retrieving session represents a face-to-face interview between the practitioner and patient, in which the data items are populated based on patient responses. The results are generated guidelines provided during the current session so that the practitioner may adjust treatment based on the results, rather than after the patient session when adjustments may be more difficult. The application 116 then renders the retrieved guideline on the user device 110 at the point of care, as depicted at step 210. Further, generation of results during the patient context allows simultaneously rendering a plurality of results based on data items populated at the point of care in the current patient context, such that each result is based on a retrieved guideline, each guideline defined by at least one rule from the rules engine, as disclosed at step 212. The result is an alert, discussed further below, indicating a suggested course of action or conclusion based on previously accumulated patient data, drug data, or other knowledge base. In the example arrangement, the result may be a statistical fact defining percentages of previously entered data items corresponding to the received data item in previous contexts, for example.

In the example medical environment depicted, the decision support results based on the rule engine or other knowledge base derives from several levels of intervention into assisting the professional. A practitioner such as a doctor may invoke a computer as a documenter, to assist with codifying information (i.e. data entry), as a helper, to manipulate data, such as invariant drug interactions, and at a colleague level, to offer guidance for judgment where reasonable minds may differ. A further level of support is in the form of a mentor, where previously entered data by more experienced practitioners is drawn on for guidance and honing of professional skills Comparison of data items and subsequent analysis differs from conventional data validation because validation occurs only at a helper level for invariant conclusions such as incompatible drug interactions.

Intervention at the colleague and mentor levels may take several forms—domain knowledge and statistical criteria. Statistical criteria can advise on demographic based ranges for identifying groups of similarly situated patients and a corresponding course of treatment, such as “90% of patients under 18 received drug X for a diagnosis of Y.” Domain knowledge identifies trends among the data items and patient history and intervenes at the mentor level.

In the medical practice environment disclosed, the alerts assist with several key areas. Alerts ensure document completeness—that corresponding or required fields are not omitted or fall outside of acceptable ranges. Clinical recommendations may be made for items such as statistical distribution of treatment options. Clinical recommendations are not “correct” or “incorrect” as incomplete documents, but rather suggest reasonable alternatives without labeling the entered data items as incorrect. Also, business stability is facilitated with revenue cycle alerts to indicate that diagnoses and procedures are appropriately coded for billing, so that charges for services accurately reflect the procedures performed or services rendered.

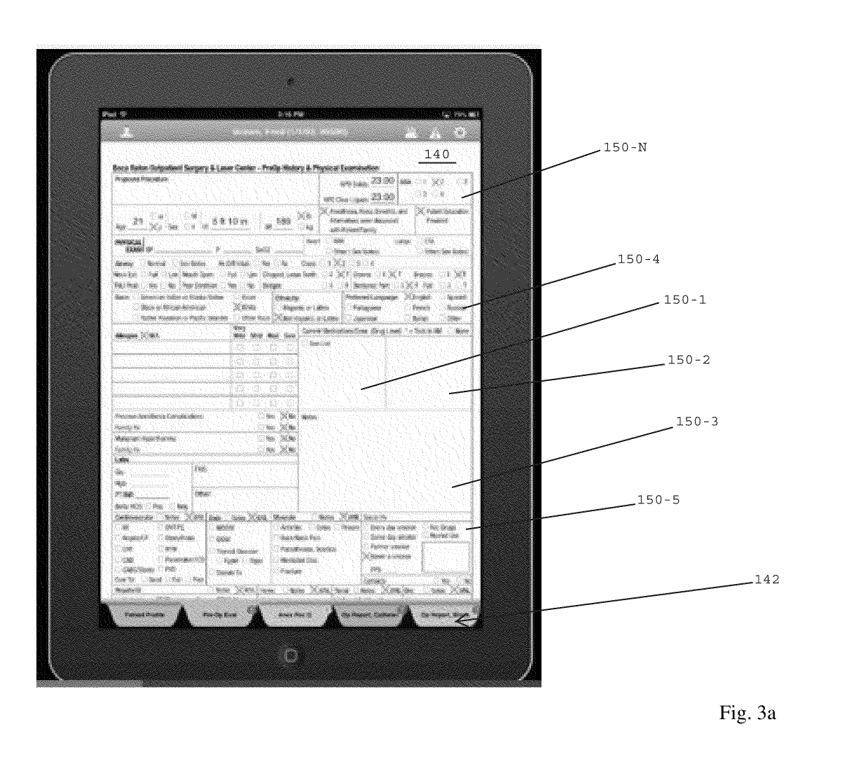

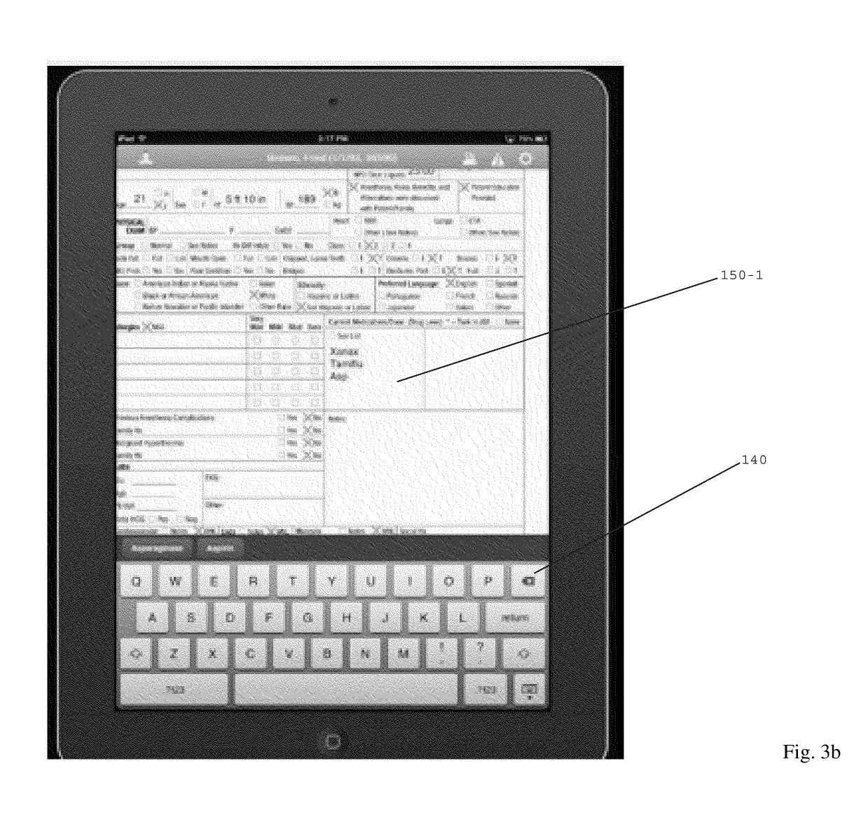

FIGS. 3a-3b show a user interface screen for decision support in the environment of FIG. 1. Referring to FIGS. 1, 3a and 3b, the application 116 renders a data form 140 on the screen 122 having a plurality of entry boxes 150-1 . . . 150-N (150 generally), each corresponding to a particular data item 112. During the context of the exchange, the user 120 populates the windows 150 with data items 112 based on information received during the patient session. A keyboard 140 (either on-screen selectable or on a permanent i.e. laptop device) allows entry of the data items 112, for example data item 150-1 is populated with the medication selections “Xanax, Tamiflu, Aspirin.” Many entry boxes 150 corresponding to a plurality of available data items 112 may exist on a particular data form; for simplicity and clarity not all available entry boxes are referenced.

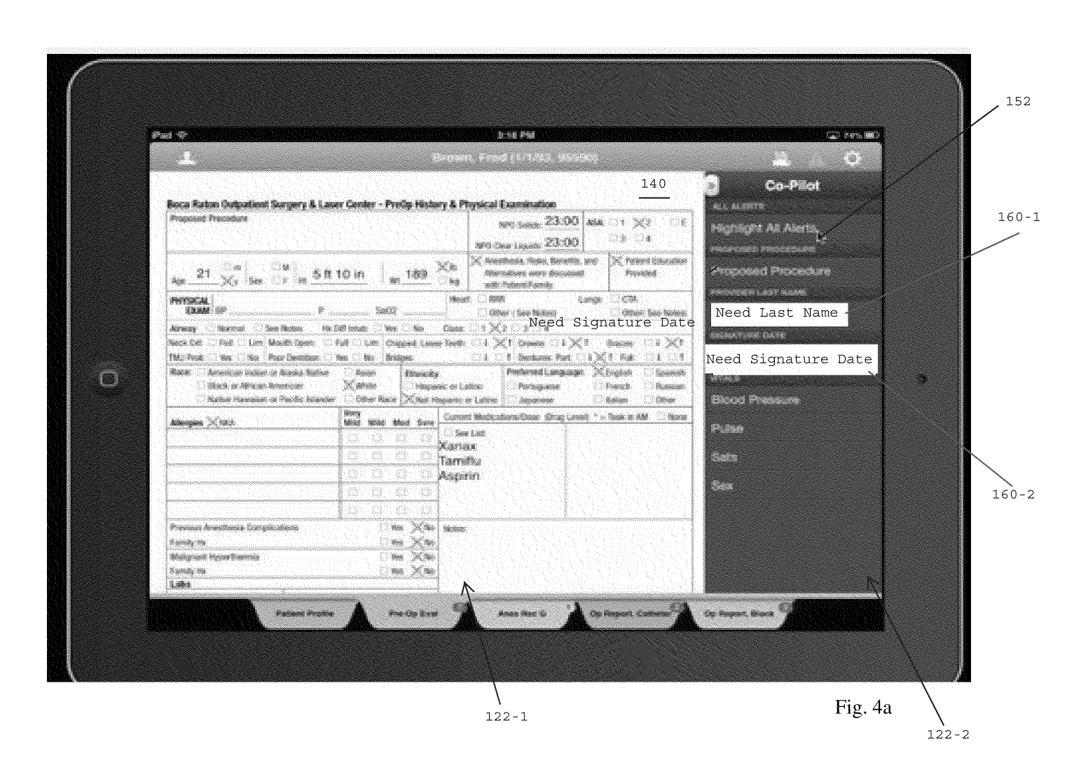

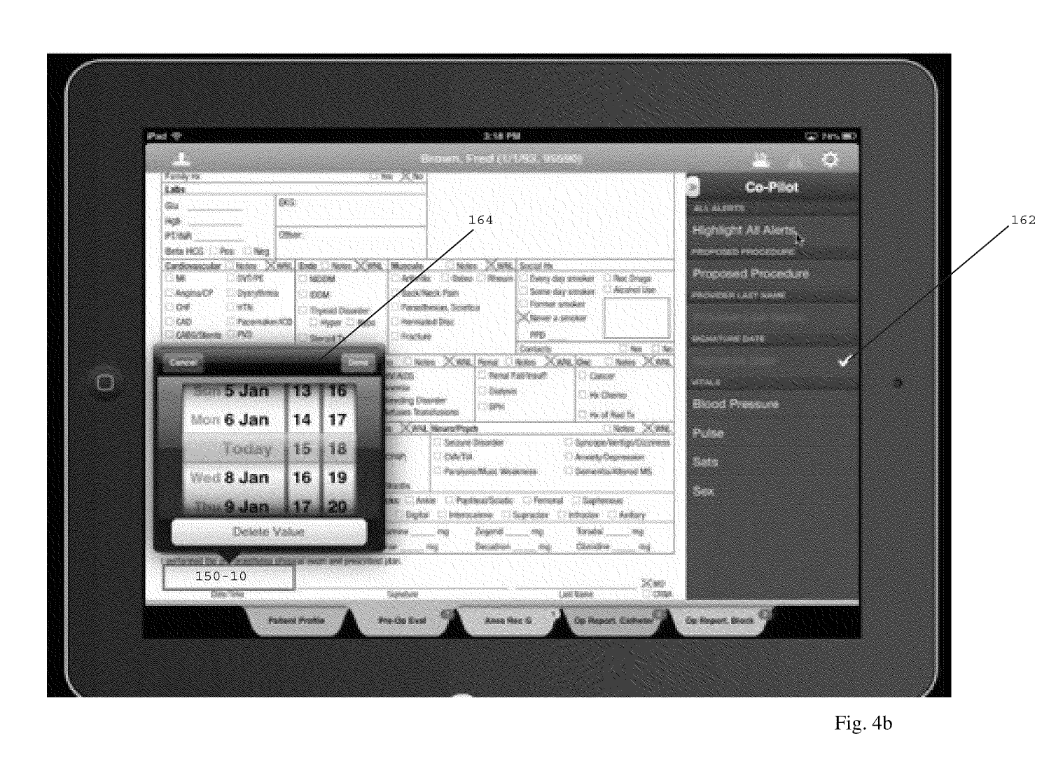

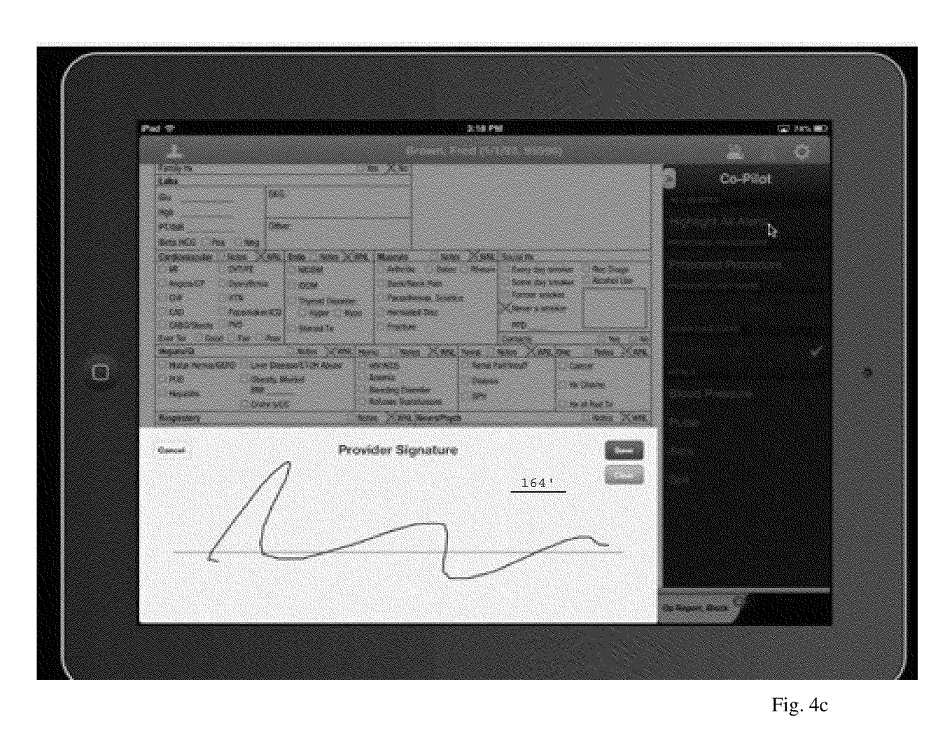

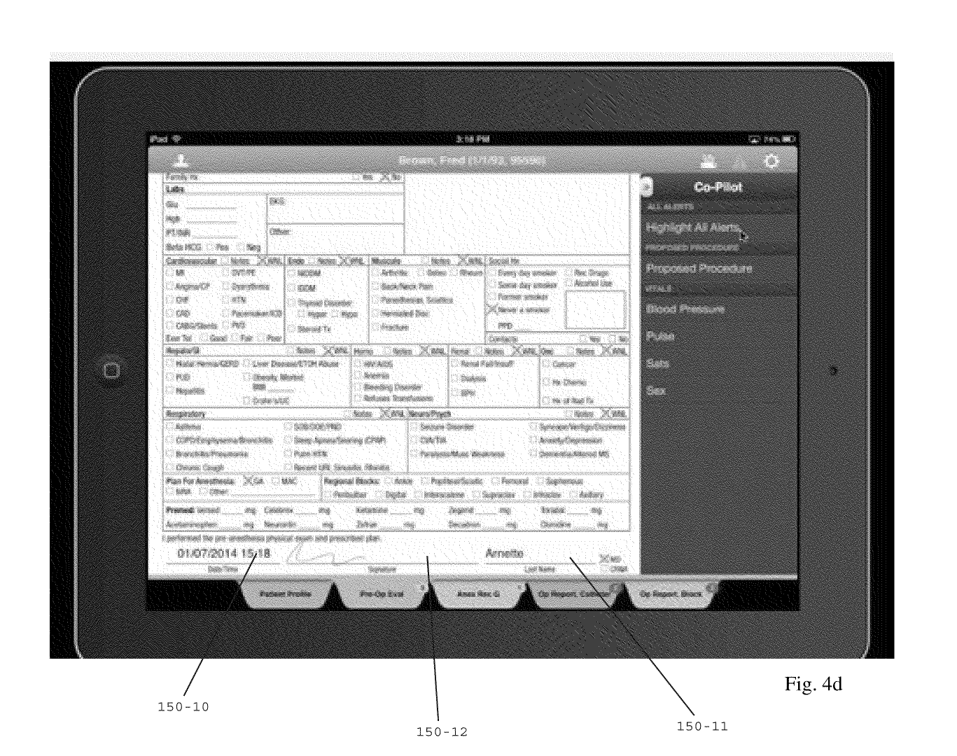

FIGS. 4a-4d show a rendering of decision support alerts according to the flowchart of FIG. 2 based on data entered as in FIGS. 3a-3b. A decision support mode is entered by turning the user device 110 lengthwise for landscape rendering, or alternatively by selection from a control tab 142 or other selection. Referring to FIGS. 4a-4d, the landscape orientation allows screen 122 to subdivide into an area for an alerts window 122-2 adjacent the data form window 122-1. The alerts window 122-2 indicates when required information has not been completed, and indicates an available revision to the entered data item that the user may wish to consider. The alerts window 122-2 itemizes any data items 112 for which anomalies are found, based on analysis with other data items 112 and with external data such as patient bibliographic information. For example, the alerts may include harmful drug interactions (data item to data item analysis), drug allergies (data item to patient data analysis), and clinical observations such as a percentage of similarly aged patients being given a different drug for the same ailment.

In the example shown, in the alerts window 122, a pointer icon 152 allows a user selection to show alerts. This enables individual notifications 160-1 . . . 160-2 (160 generally) of omissions or anomalies. The notification 160-1 indicates that a provider last name (typically that of the user entering the data items 112) is missing and notification 160-2 indicates that a provider signature date is missing. The pointer 152 selects to provide the signature date, shown by check 162 as the selected notification 160 to address. An entry icon 164, cognizant of the date nature of the omitted data, assists in entry of the data item 150-10. Following entry of the provider last name 150-11, another entry icon 164′ prompts for the user signature 150-12.

In many cases, the alert indicates a deviation in a received value for the data item compared to previously received values for the same data item in similar patient contexts, based on a statistical analysis. Such guidelines may achieve a mentoring capacity by deriving guidelines from data items based on entries of more experienced practitioners, as discussed above. The guideline codified as rule is based on a combination of domain knowledge and statistical criteria, such that the domain knowledge derives from stored conclusions of other practitioners in similar contexts and the statistical criteria is based on percentages of practitioners acting in a similar manner.

The application 116 therefore, generates alerts after receiving a first input for a data item, receiving a second input or a data item, and correlating the first data item with the second data item based on previous values for the first and second data items. If the plurality of data items 150 on the form 140 triggers a rule, the application generating a result in the alerts window 122-2 based on the correlation. Generating the alerts includes rendering a graphical user interface (GUI) form 140 with the first and second data items, and rendering the alerts window 122-2 on the GUI form 140. The alerts window 122-2 contains a list of results from correlation of data items on the GUI form, such that each result defines an alert. Any number of alerts may be generated based on rules triggered by data items 150 on the current form 140. The application 116 updates the alerts window 122-2 based on resolution of the alerts as the data items 150 receive values that satisfy the alert. The number of alerts 160 in the alerts widow 122-2 can expand and contract based on the alerts triggered by current data items 150. Users can choose to ignore or resolve the alerts, as some alerts are merely advisory and others may be resolved as corresponding values are entered for data items 150 not yet encountered.

The alerts as shown in FIGS. 4a-4d continually update based on rule based analysis and therefore the alerts expand and contract dynamically as items are resolved. The rendered guideline 160 or alert remains until resolution, in which resolution occurring by either a received acknowledgement of the alert of the content therein, or a received data item that satisfies a condition represented by the alert, such that the condition results from a detected deviation from the previous data values entered for the data item.

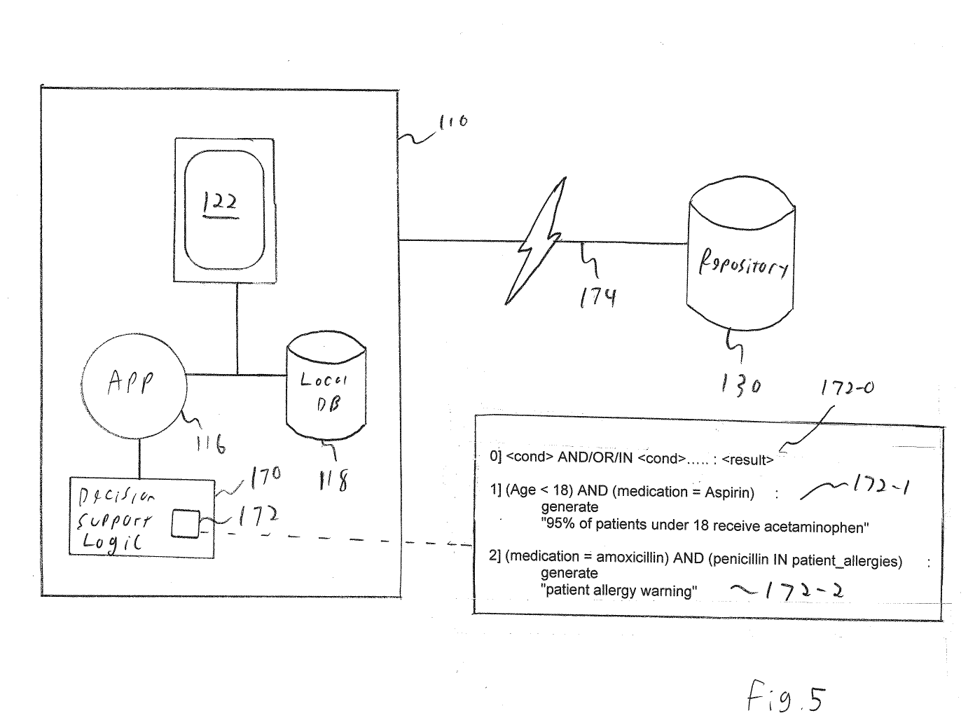

FIG. 5 shows logic for determining alerts for rendering as in FIG. 4. Referring to FIGS. 1 and 5, the user device 110 includes the GUI rendering screens 122 on a typical display LCD or LED panel, the launched application 122, and the local database 118 for immediate retrieval of relevant data. Retrieving the guideline includes invoking a rules engine for computing satisfaction of conditions defining a rule, such that the guideline is indicative of at least one of clinical decisions, documentation completeness and revenue criteria, as disclosed above. The application 116 further invokes decision support logic 170, including the rules engine responsive to a rule set 172. The local DB 118 stores a rule set 172 sufficient for the user device 110, and refreshes periodically from an external or central server repository 130 via a communications link 164 using the network 132, typically including a wireless link. The decision support logic m170 monitors received data items 150, and compares them to the rule set 162 to determine triggering of rules that initiate the alerts 170. In the example configuration, the application 116 invokes the rule set 172 following each data item 150 entry, and compares the data item 150 to other data items on the form 140 and to patient bibliographic information such as age, gender, and medical history.

The disclosed rule set is an example and may be expressed in other forms and for use with alternate mechanisms for generating decision support results. In the example shown, the rule set 172 includes a syntax specifier 172-0, indicating the format of the rule as a series of conditions, connected by logic relations (AND, OR, IN etc.), and a result indicating the message rendered upon triggering of the rule. Rule 172-1 shows interrelation of data items 150 with patient data correlated with statistical data, to render a statistical fact to the user 120 that acetaminophen is used in 95% of cases where the patient is a minor. Rule 172-2 correlates patient history with data items to trigger an allergy warning.

Those skilled in the art should readily appreciate that the programs and methods defined herein are deliverable to a user processing and rendering device in many forms, including but not limited to a) information permanently stored on non-writeable storage media such as ROM devices, b) information alterably stored on writeable non-transitory storage media such as floppy disks, magnetic tapes, CDs, RAM devices, and other magnetic and optical media, or c) information conveyed to a computer through communication media, as in an electronic network such as the Internet or telephone modem lines. The operations and methods may be implemented in a software executable object or as a set of encoded instructions for execution by a processor responsive to the instructions. Alternatively, the operations and methods disclosed herein may be embodied in whole or in part using hardware components, such as Application Specific Integrated Circuits (ASICs), Field Programmable Gate Arrays (FPGAs), state machines, controllers or other hardware components or devices, or a combination of hardware, software, and firmware components.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. A method for clinical decision support, comprising:
receiving, during a patient data receiving session, a data item pertaining to care of the patient;
analyzing the data item in view of a decision concerning patient care;
retrieving, in the context of the current data receiving session, a guideline for the decision; and
rendering a result indicative of the retrieved guideline at the point of care.

2. The method of claim 1 wherein analyzing further comprises:
comparing the received data item to at least one other data item; and
identifying, based on the comparison, a rule reflecting a result.

3. The method of claim 1 further comprising:
receiving a first input for a data item;
receiving a second input or a data item;
correlating the first data item with the second data item based on previous values for the first and second data items; and
generating a result based on the correlation.

4. The method of claim 3 wherein the result is a statistical fact defining percentages of previously entered data items corresponding to the received data item in previous contexts.

5. The method of claim 3 further comprising:
rendering a graphical user interface (GUI) form with the first and second data items; and
rendering an alerts window on the GUI form, the alerts window containing a list of results from correlation of data items on the GUI form, each result defining an alert updating the alerts window based on resolution of the alerts.

6. The method of claim 5 wherein the rendered guideline remains until resolution, resolution occurring by at least one of:
a received acknowledgement of the alert of the content therein; or
a received data item that satisfies a condition represented by the alert, the condition resulting from a detected deviation from the previous data values entered for the data item.

7. The method of claim 5 wherein the alert indicates a deviation in a received value for the data item compared to previously received values for the same data item in similar patient contexts.

8. The method of claim 1 further comprising simultaneously rendering a plurality of results based on data items populated at the point of care in the current patient context, each result based on a retrieved guideline, each guideline defined by at least one rule.

9. The method of claim 1 wherein the guidelines achieve a mentoring capacity by deriving guidelines from data items based on entries of more experienced practitioners.

10. The method of claim 1 wherein the guideline is based on a combination of domain knowledge and statistical criteria, the domain knowledge based on stored conclusions of other practitioners in similar contexts and the statistical criteria based on percentages of practitioners acting in a similar manner.

11. The method of claim wherein retrieving the guideline further comprises invoking a rules engine for computing satisfaction of conditions defining a rule, the guideline indicative of at least one of clinical decisions, documentation completeness and revenue criteria.

12. A user device for clinical decision support, comprising:
a Graphical User Interface (GUI) for receiving, during a patient data receiving session, a data item pertaining to care of the patient;
decision support logic for analyzing the data item in view of a decision concerning patient care;
a data repository for retrieving, in the context of the current data receiving session, a guideline for the decision; and
a display screen for rendering a result of the retrieved guideline at the point of care.

13. The user device of claim 12 wherein the decision support logic is configured to:
compare the received data item to at least one other data item;
identify, based on the comparison, a rule reflecting the result.

14. The user device of claim 12 wherein the GUI is configured to:
receiving a first input for a data item;
receiving a second input or a data item;
the decision support logic for correlating the first data item with the second data item based on previous values for the first and second data items, and generating the result based on the correlation.

15. The user device of claim 14 wherein the result is a statistical fact defining percentages of previously entered data items corresponding to the received data item in previous contexts.

16. The user device of claim 14 wherein the display screen is further configured to:
render a graphical user interface (GUI) form with the first and second data items; and
render an alerts window on the GUI form, the alerts window containing a list of results from correlation of data items on the GUI form, each result defining an alert; and
update the alerts window based on resolution of the alerts.

17. The user device of claim 16 wherein the GUI is operable to maintain the rendered result until resolution, resolution occurring by at least one of:
a received acknowledgement of the alert of the content therein; or
a received data item that satisfies a condition represented by the alert, the condition resulting from a detected deviation from the previous data values entered for the data item.

18. The user device of claim 16 wherein the alert indicates a deviation in a received value for the data item compared to previously received values for the same data item in similar patient contexts.

19. The user device of claim 12 further comprising a rules engine, the rules responsive to the decision support logic for computing satisfaction of conditions defining a rule, the guideline indicative of at least one of clinical decisions, documentation completeness and revenue criteria.

20. A computer program product on a non-transitory computer readable storage medium having instructions that, when executed by a processor, perform a method for clinical decision support, the method comprising:
receiving, during a patient data receiving session, a data item pertaining to care of the patient;
analyzing the data item in view of a decision concerning patient care;
retrieving, in the context of the current data receiving session, a guideline for the decision; and
rendering the retrieved guideline at the point of care.
